(19) United States
(12) Patent Application Publication
(10) Pub. No.: US 2020/0374402 A1
(43) Pub. Date: Nov. 26, 2020

(54) GENERATING AND PROVIDING ESTIMATED WAIT TIME OPTIONS IN CONTACT CENTERS

(71) Applicant: Talkdesk, Inc, San Francisco, CA (US)

(72) Inventor: Jafar Adibi, San Francisco, CA (US)

(21) Appl. No.: 16/550,987

(22) Filed: Aug. 26, 2019

Related U.S. Application Data
(60) Provisional application No. 62/850,663, filed on May 21, 2019.

(51) Int. Cl. H04M 3/523; H04M 3/51

(52) U.S. Cl. CPC H04M 3/5238; H04M 3/5231; H04M 3/5183; H04M 3/5141

(57) ABSTRACT

One or more embodiments described herein provide benefits and solve some of the foregoing or other problems in the art with systems, methods, and non-transitory computer readable media that generate and provide estimated wait time in a manner that allows a contacting user to make informed decisions and even control how the customer waits for an agent, if the customer waits for an agent, and how long the customer waits for an agent. For example, the system can provide an administrator device a user interface that allows the administrator to define the delivery of an estimated wait time (EWT) at any point within a contact flow (e.g., a road map of how a call will be handled from the moment they enter the system to the end of the call). In addition, based the estimated wait time setup, the system can provide various EWT options to the contacting user.

### CROSS-REFERENCE TO RELATED APPLICATIONS

This application claims priority to U.S. Provisional Application Ser. No. 62/850,663 filed on May 21, 2019. The contents of which are hereby incorporated by reference.

### BACKGROUND

Modern contact centers use a variety of technology to attempt to schedule agents to meet the demand of contacting users in order to respond to contacting users as quick as possible. Despite these attempts, the reality of unexpected surges in contacting user volume, agent no-shows, and budgeting constraints often leave a contacting center under-staffed, and thus cause contacting users to have to wait a period of time before being connected to an agent. Depending on the period of time a contacting user has to wait, some contacting users decide to end the communication to try again later, others wait for several minutes before eventually disconnecting, while others still wait a long amount of time which leads to frustration and often wasted time for the contacting user.

Convention contact centers have a number of disadvantages when dealing with contacting user wait times that decrease the flexibility and efficiency of conventional contact centers. For example, while many conventional contact centers provide an estimated wait time at a beginning of a call, conventional contact centers typically provide no additional updates about the wait time and therefore leave a contacting user guessing as to how much longer they must wait to be connected to an agent. In addition, the manner in which conventional contact centers manage the wait time of a contacting user causes the contacting user to physically listen to the phone for the duration of the wait. Furthermore, convention contact centers are inflexible and do not allow a contact center administrator the ability to manage the generation and delivery of estimated wait times, and similarly, this inflexibility extends to the contacting user as conventional systems provide almost no options to a waiting contacting user other than to continue to wait or to disconnect. Because of these and other limitations with conventional contact centers, contacting users make uninformed decisions about when to disconnect or when to continue to wait, which leads to system inefficiencies in handling contacting user demand and resulting in an overall negative impact to the contact center as a whole.

Thus, there are several disadvantages with regard to conventional contact center systems.

### SUMMARY

One or more embodiments described herein provide benefits and solve one or more of the foregoing or other problems in the art with systems, methods, and non-transitory computer readable media that generate and provide estimated wait time in a manner that allows a contacting user to make informed decisions and even control how the customer waits for an agent, if the customer waits for an agent, and how long the customer waits for an agent. For example, the system can provide an administrator device a user interface that allows the administrator to define the delivery of an estimated wait time (EWT) at any point within a contact flow (e.g., a road map of how a call will be handled from the moment they enter the system to the end of the call). In addition, based the estimated wait time setup, the system can provide various EWT options to the contacting user. For instance, the system can provide the EWT through a different communication channel than the channel through which the contacting user connected to the system. Moreover, the system can allow the contacting user to request an updated EWT at any point during the contact flow, which allows the contacting user to make waiting decisions with the most up-to-date EWT information. Additionally, the system can provide EWT options that allow the contacting user to request a contact-back via a different channel at a later time and/or in addition, add time to the EWT to make sure that the contacting user is available at the time the agent becomes available. These and other features increase the efficiency and flexibility of the system by allowing contacting users to control some portion of the wait time to meet their specific needs and schedule, which results in fewer contact attempts and more even distribution of agent demand over time.

Additional features and advantages of the present application will be set forth in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment for implementing a communication management system in accordance with one or more embodiments;

FIG. 2 illustrates a contact flow and EWT announcement or request points in accordance with one or more embodiments;

FIG. 3 a flow to allow an administrator to define an EWT variable in accordance with one or more embodiments;

FIGS. 4A-4D illustrate example graphical user interfaces of the communication management system in accordance with one or more embodiments;

FIG. 5 illustrates an example sequence flow for generating and processing EWT information and options;

FIG. 6 illustrates an example computing device in accordance with one or more embodiments; and

FIG. 7 illustrates an example communication system in accordance with one or more embodiments.

### DETAILED DESCRIPTION

One or more embodiments described herein provide benefits and solve one or more of the foregoing or other problems in the art with a communication management system that generates and provides estimated wait time (EWT) options to a contacting user to increase the efficiency and flexibility of the communication management system. In particular, the communication management system provides unique graphical user interfaces that allow an administrator to define EWT events throughout a contact flow (e.g., a roadmap of how an interaction with the communication management system will be handled from the moment of connecting the communication management system to the end of the interaction). Based on the EWT events, the communication management system can provide EWT information and options to a contacting user that allows the contacting user to control various aspects of a wait time in a way the improves wait time expectations, increases call handling efficiencies for the communication management system, and levels out agent demand within the communication management system over time.

For example, in one or more embodiments the communication management system can provide an administrator device a graphical user interface that allows an administrator of a contact center to define EWT handling within the communication management system. For example, using the graphical user interface, the administrator can define EWT properties and settings that define how and when EWT information and options are provided to contacting users throughout a contact flow. For instance, the communication management system allows the administrator to define communication channels through which an EWT is provided, contact-back options, updated EWT options, and points within a contact flow where the communication management system can make one or more options available to the contacting user.

As just mentioned above, the communication management system can provide a contacting user EWT information at any point during a contact. For example, unlike conventional systems, the communication management system can provide updated EWT information at various points within a contact flow. For instance, the communication management system can provide EWT information and options at the start of a contact, after IVR (interactive voice response) selection, at any point during a waiting period, at a point after a contact transfer, and/or at any other point within a contact flow.

In addition to providing EWT information at various points of a contact flow, the communication management system can provide an EWT via a different channel of communication than the channel of communication the contacting user employed to originally contact the communication management system. For example, a contacting user can call the communication management system and the communication management system can provide an EWT to the contacting user via SMS and/or email. In this way, the communication management system can provide EWT updates via a communication channel that allows the contacting user to put down the phone to wait while also getting updates on the EWT via a different communication channel. The end result is a more efficient communication management system because the alternative channel EWT reporting allows a contacting user to more easily wait for an agent rather than ending a call and trying again later.

Moreover, the communication management system can allow the contacting user to request an updated EWT at any point during the contact flow. For example, the communication management system can receive a request from a contacting user's device via a voice request, a touch-tone request, or text request, and in response to the request the communication management system can generate an updated EWT and provide the updated EWT to the contacting user's device via one or more communication channels. In this way, the contacting user can continually have access to the most up-to-date EWT information that allows the contacting user to make the best decision to either wait, request a different EWT option (as explained below), or disconnect the call and try again later.

As just mentioned, the communication management system can provide additional EWT options to the contacting user via the contacting user device. For example, the communication management system can provide a contacting user an option to have the communication management system contact-back the user via a different channel. For example, if a contacting user originally calls the communication management system, the communication management system can provide a contact-back option to the contacting user that allows the contacting user to select an option to have the communication management system contact the contacting user at a later time using a SMS text.

In addition to providing a contact-back option, the communication management system can provide an EWT option to allow the contacting user to add additional time to the wait. For example, a contacting user may have been waiting 15 minutes for an agent and the contacting user in next in the que for an agent. However, the contacting user is no longer in the position to talk to the agent (e.g., the contacting user just arrived home and needs to transition from the car to the home). Accordingly, the contacting user can send a request to the communication management system to add an additional 5 minutes to the wait time to allow the contacting user to get in the position to talk to the agent. In this way, instead of simply disconnecting the call after waiting 15 minutes, the contacting user can increase the wait time a defined amount, which in turn increases efficiency of the system to not have wasted the 15 minutes of waiting.

As illustrated by the foregoing discussion, the present disclosure utilizes a variety of terms to describe features and benefits of the communication management system. Additional detail is hereafter provided regarding the meaning of these terms as used in this disclosure. In particular, the term “estimated wait time” or “EWT” refers to an expected time that a contacting user will wait before they can communicate (e.g., via voice, text, email, chat, etc.) with an agent. EWT is independent of channel of communication and the EWT could be the time to talk to an agent, the time to chat in a chat thread with an agent, or a time to one of the two (e.g., a combined EWT). In other words, the EWT is channel agnostic and could be a phone call, a chat, an email or any other type of communication. Moreover, the EWT could be associated with a specific agent (the person) or virtual agent (e.g. chatbot) or a group of agents (aka ring group)—for instance those who are associated with sales or support. In one or more embodiments, the EWT is retrieved in seconds, min or a segment of the time (for instance “less than a min” or “more than 30 min”). Furthermore, in one or more embodiments, the EWT value does not take into consideration the time the contact has already been waiting for the agent. In other words, the communication management system generates an EWT by analyzing the status of the system, the number of agents, the average call times, the number of other contacting users in the queue, as well as additional information to generate an estimated time each time the system announces or is requested to announce EWT information.

In particular, the term “contacting user” refers to a user that contacts the communication management system. A contacting user can refer to a user that is experiencing a problem or issue with a service system and that contacts the communication management system in an attempt to resolve the problem or to inform others of the problem. For example, a contacting user can include a caller, a chat user, or a text message user that sends an electronic communication to the communication management system.

Relatedly, the term “agent user” refers to an individual or system associated with the communication management system or a service system and that assists a contacting user via electronic communication correspondence. Indeed, the communication management system can connect a contacting user who needs to reschedule a flight with an agent user affiliated with the relevant airline system.

The term “communication” refers to a communication such as a phone call, chat message, text message, instant message, or video call that the communication management system can receive from a contacting user.

Additionally, the communication management system determines one or more options for processing a communication. As used herein, the term “option” refers to an action or series of actions that the communication management system can take to process an electronic communication. In some embodiments, an option can refer to an automatic system-performed act to accomplish a purpose, while in other embodiments an option can refer to an action to acquire as selection from another actor (e.g., an agent or contacting user) to accomplish a predicted purpose.

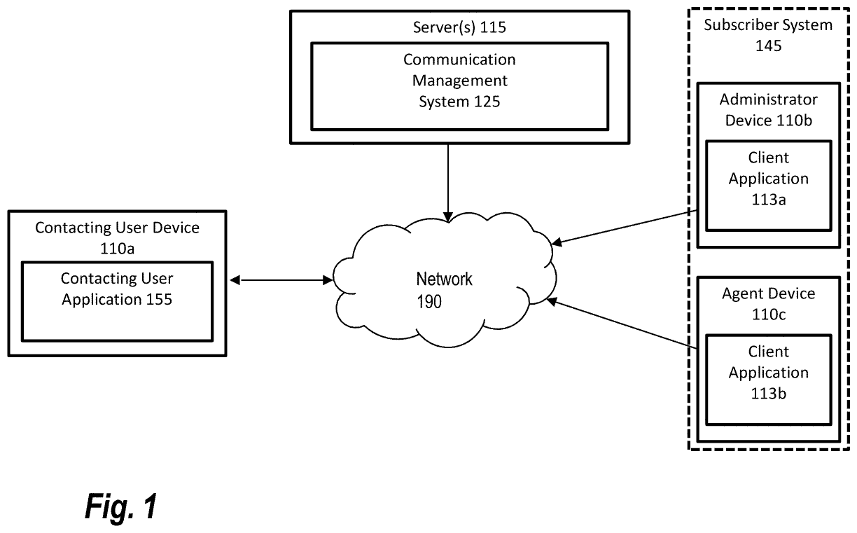

Additional detail regarding the communication management system will now be provided with reference to the figures. For example, FIG. 1 illustrates a schematic diagram of an example environment for implementing a communication management system in accordance with one or more embodiments. An overview of the communication management system is described in relation to FIG. 1. Thereafter, a more detailed description of the components and processes of the communication management system is provided in relation to the subsequent figures.

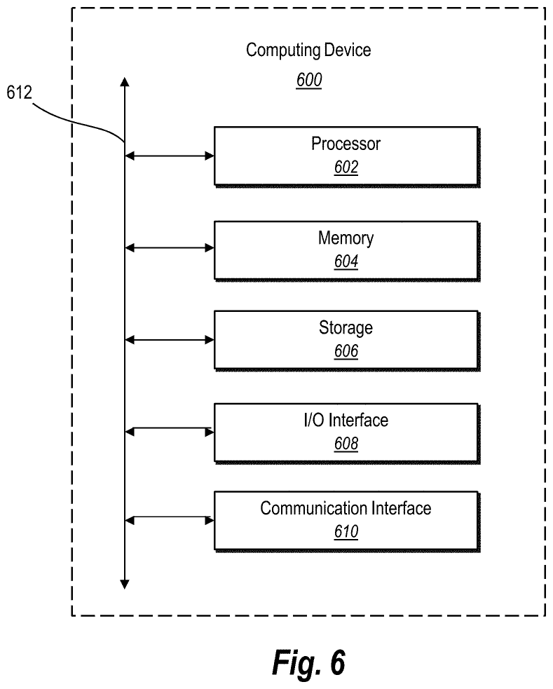

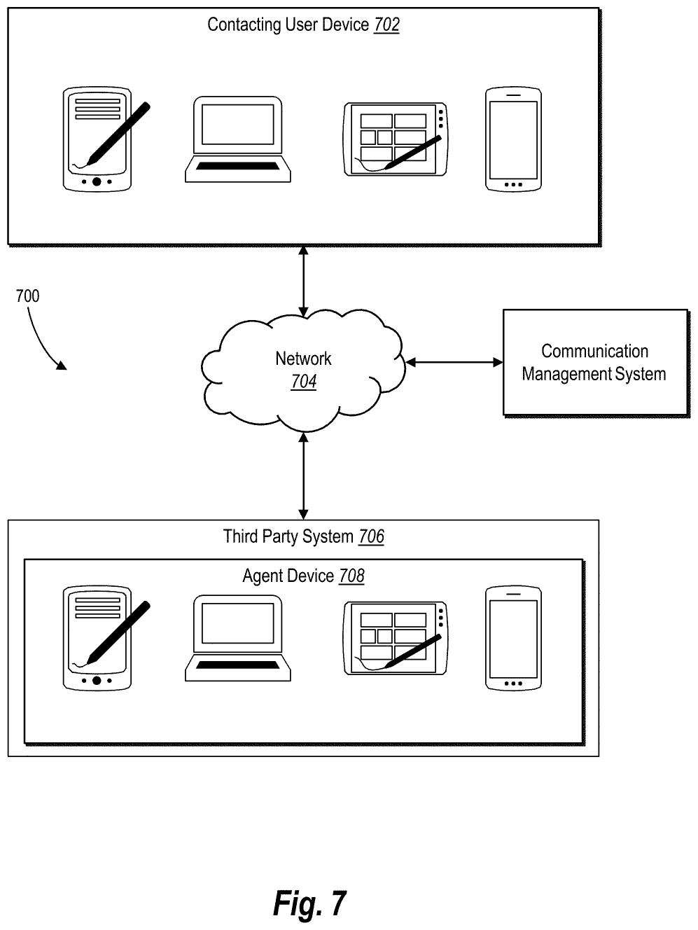

As shown in FIG. 1, the environment includes server(s) 115, an administrator device 110b, an agent device 110c, a contacting user device 110a, a subscriber system 145, and a network 109. Each of the components of the environment can communicate via the network 109, and the network 109 may be any suitable network over which computing devices can communicate. Example networks 109 are discussed in more detail below in relation to FIGS. 6 and 7.

As mentioned, the environment includes different client devices 110 such as a contacting user device 110a, and administrator device 110b, and an agent device 110c. The contacting user device 110a can be one of a variety of computing devices 110, including a smartphone, tablet, smart television, desktop computer, laptop computer, virtual reality device, augmented reality device, or other computing device as described in relation to FIGS. 6 and 7. Although FIG. 1 illustrates a single contacting user device 110a, in some embodiments the environment can include multiple different contacting user devices 110a, each associated with a different contacting user. The contacting user device 110a can receive user input and other information and provide the information (including communication dialogue and contacting user information) to the server(s) 115.

As shown, the contacting user device 110a includes a contacting user application 155. In particular, the contacting user application 155 may be a web application, a native application installed on the contacting user device (e.g., a mobile application, a desktop application, etc.), or a cloud-based application where part of the functionality is performed by the server(s) 115. The contacting user application 155 can present or display information to a contacting user, including information relating to EWT options for processing an electronic communication to help a contacting user accomplish a desired purpose. A contacting user can interact with the contacting user application 155 to provide user input to, for example, select an EWT option for processing an electronic communication or provide communication dialogue.

As also mentioned, the environment includes an administrator device and an agent device Like the contacting user device, the administrator device 110b and agent device 110c can be a one of a variety of computing devices 110, including a smartphone, tablet, smart television, desktop computer, laptop computer, virtual reality device, augmented reality device, or other computing device as described in relation to FIGS. 6 and 7. Although FIG. 1 illustrates a single agent device, in some embodiments the environment can include multiple different agent devices 110c, each associated with a different agent user. The agent device can receive user input from an agent user and receive information (including communication dialogue, contacting user information, a purpose prediction, and/or an agent transcript) from the server(s).

As shown, the administrator device 110b and agent device 110c include a client application 113 (e.g., the applications 113a and 113b). In particular, the client application 113 may be a web application, a native application installed on the administrator device 110b or agent device 110c (e.g., a mobile application, a desktop application, etc.), or a cloud-based application where part of the functionality is performed by the server(s). The client application 113 can present or display information to an administrator or agent user, including a user interface for interacting with a contacting user and presenting information pertaining to the contacting user (e.g., contextual information, an agent transcript, etc.). An agent user can interact with the agent application to, for example, help a contacting user with a customer service issue. In addition, the administrator can interact with the client application 113 to define EWT points, options, and behavior as described herein.

As illustrated in FIG. 1, the environment includes a subscriber system 145. The subscriber system 145 may be a service system or a different customer support system. For example, the subscriber system 145 may be a service system that is currently experiencing or exhibiting a problem feature relevant to a contacting user. As another example, the subscriber system 145 may be a service system that is not currently experiencing a problem feature but that a contacting user needs to contact to resolve an issue stemming from a problem feature of a different service system—e.g., an airline system that a contacting user calls to reschedule a flight due to being stuck in traffic. In some embodiments, as indicated by the dashed box of FIG. 1, the agent device 110c is associated or affiliated with the subscriber system 145. In these embodiments, the communication management system 125 may provide information such as an electronic communication and contacting user information to the subscriber system 145, whereupon the subscriber system 145 may assign or relay the electronic communication to an agent device 110c. In other embodiments, the agent device 110c is not directly associated with the subscriber system 145, and the communication management system 125 provides information to the agent device 110c without necessarily utilizing the subscriber system.

As further illustrated in FIG. 1, the environment includes the server(s) 115. The server(s) 115 may generate, store, process, receive, and transmit electronic data, such as electronic communications, communication dialogue, contacting user information, contextual information, and purpose predictions. For example, the server(s) 115 may receive data from the contacting user device in the form of an electronic communication and contacting user information. In addition, the server(s) 115 can transmit data to the agent device 110c to provide the electronic communication and contacting user information. The server(s) 116 can communicate with the contacting user device 110a, the agent device 110c, and the subscriber system 145 to transmit and/or receive data via the network 190. In some embodiments, the server(s) 115 comprises an application server, a communication server, a web-hosting server, a social networking server, a digital content campaign server, or a digital content management server. Although FIG. 1 depicts the communication management system 125 located on the server(s) 115, in some embodiments, the communication management system 125 may be implemented by (e.g., located entirely or in part) on one or more other components of the environment. For example, the communication management system 125 may be implemented by the contacting user device 110a, the agent device 110c, and/or the subscriber system 145.

In some embodiments, though not illustrated in FIG. 1, the environment may have a different arrangement of components and/or may have a different number or set of components altogether. For example, the contacting user device 110a, the agent device 110c, and the subscriber system 145 may communicate directly with the communication management system 125, bypassing the network 190. Additionally, the communication management system 125 can include one or more databases (e.g., a database to store contacting user information, contextual information, and/or generated purpose predictions) housed on the server(s) or elsewhere in the environment. The communication management system 125 can be implemented in a variety of different ways across the server(s), the network, the agent device 110c, the contacting user device 110a, and the subscriber system 145. Additional detail regarding implementing different components of the communication management system 125 across devices is provided below.

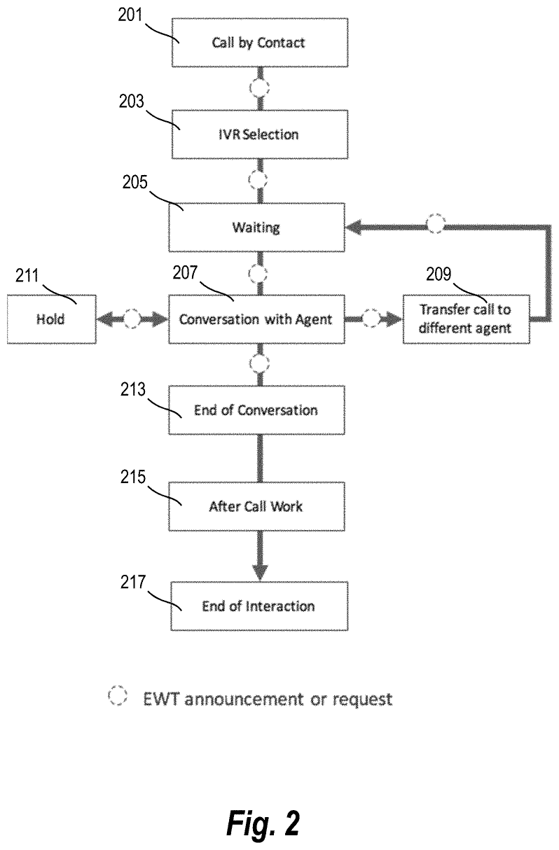

As mentioned above, the communication management system 125 can generate and provide EWT information and options at any point in a contact flow. To that end, FIG. 2 illustrates an example contact flow in which the dotted-circle represent points within the contact flow where the communication management system can provide EWT information, options, or respond to requests. For example, and as illustrated in FIG. 2, the contact flow can include receiving a call from the contacting user (201), IVR selection (203), and waiting for an agent (205). Between each of these events within the contact flow, the communication management system 125 can provide an EWT announcement or respond to an EWT request. Moreover, the EWT component can be used multiple times within the same flow or between the same contact flow events. For example, the communication management system 125 can provide the EWT multiple times during the waiting portion (205) of the contact flow, or a contacting user can request an updated EWT multiple times throughout the contact flow or multiple times at the same location within the contact flow.

In addition, and as further illustrated by FIG. 2, the contact flow can also include a conversation with an agent (207) and a transfer of the call to a different agent (209). As shown, the communication management system 125 can also provide a an EWT announcement or option before the transfer of the call (209), after the transfer of the call, and/or while the contacting user is on hold (211). In other words, the communication management system 125 can provide or otherwise receive a request to provide EWT information at any point between the start of the contact to the end of the contact, as illustrated in FIG. 2. For example, the contact is over at 213, 215, and 217, and therefore no EWT information may be provided.

The system can provide the announcement and display of the EWT in a variety of manners depending on administrator definitions or the contacting user's communication channel. For example, the system can provide the EWT via voice (e.g. “your estimated waiting time is 2 min”), via text, via a messenger, Slack, chatbots or chat widget. Moreover, the system can provide the EWT via image and video—e.g. show a number on the phone screen or computer monitor.

Similarly, the contacting user can request EWT information by using a variety of user interactions. For example, a contacting user can request EWT information by pressing a button (e.g. phone button), by asking via voice, by sending a message (e.g. send a tweet or email to specific account), or by any other potential communication channel.

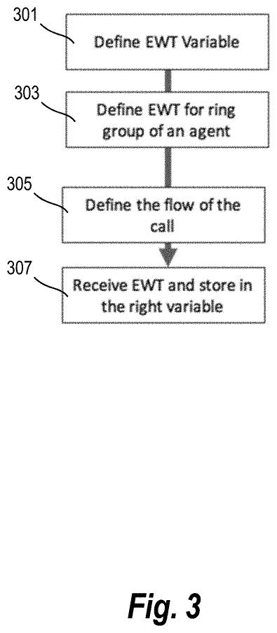

As mentioned above, the communication management system 125 allows an administrator device to define EWT events as described in FIG. 2. To this end, FIG. 3 illustrates a process flow for allowing an administrator to define EWT events and properties. For example, the administrator for the communication management system has the opportunity to define the EWT and introduce to the contact flow. The chart in FIG. 3 illustrates the process. Specifically, the administrator first defines an EWT variable (301) (e.g., announcement option, contact-back option, EWT request options, etc.). Moreover, the administrator defines the EWT for a ring group or an agent (303). For example, the administrator may select a ring group to associate with the EWT. Next the administrator defines the EWT variable within the contact flow associated with the selected ring group as described above with respect to FIG. 2 (305). For example, the administrator may place the EWT variable at a particular point in the contact flow. Finally, the communication management system receives the EWT definition and stores the EWT variable (307).

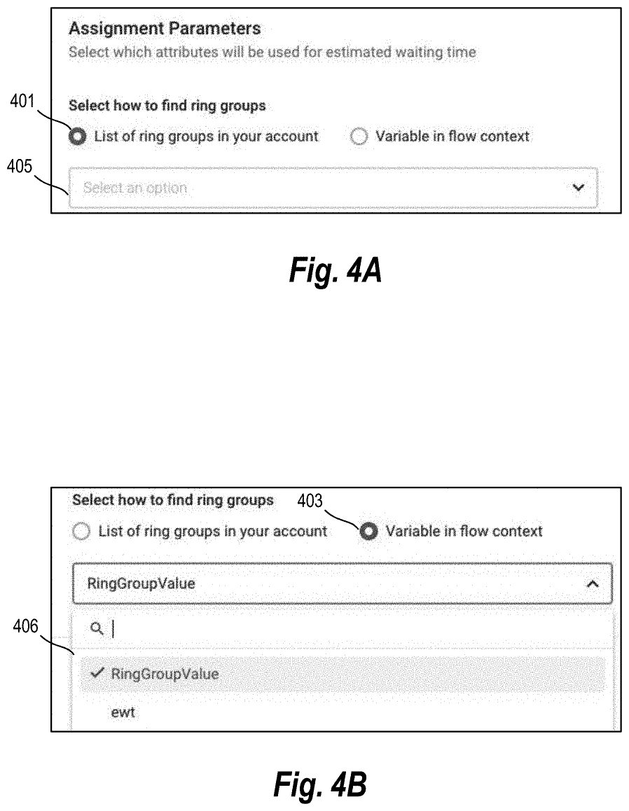

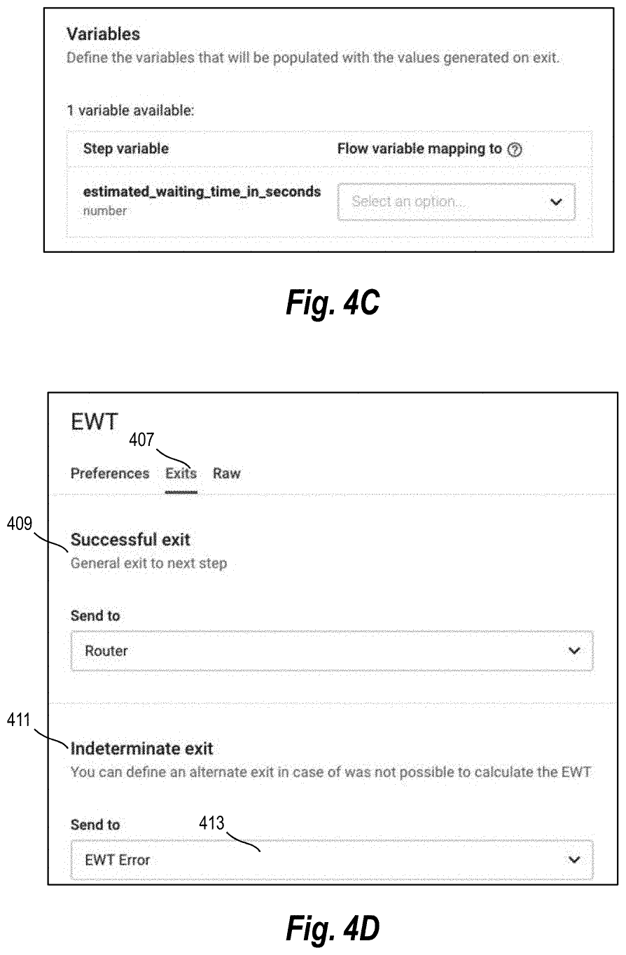

FIGS. 4A-4B illustrate example graphical user interfaces that the communication management system can provide to an administrator device to allow an administrator to define an EWT variable. For example, to get the estimated waiting time, the administrator should define the ring group which deals with a certain call. There are a variety of ways to define the ring group. For instance, and as shown in FIG. 4A, the admin selects the option 401 “List of ring groups in your account.” The communication management system provides a drop-down menu 405 that lists all the ring groups associated with the current account. The admin simply selects on the desired value. Alternatively, and as shown in FIG. 4B, the administrator selects the option 403 “Variable in flow context.” In response, the communication management system provides a drop-down menu 406 that lists all the variables available. The administrator can select the desired variable.

Next, the estimated waiting time will be stored in a flow variable defined by the administrator and that the communication system references to make routing decisions, as shown in FIG. 4C. Moreover, the exits tab 407 will provide two possible outcomes shown in FIG. 4D. If the EWT was computed properly, the administrator should define an exit on the drop-down menu below the “Successful exit” title 409. On the other hand, if the API was not able to retrieve an EWT value, then the “Intermediate exit” 411 will be triggered. The administrator can be made aware of the unknown EWT status through an EWT error 413, as indicated in FIG. 4D.

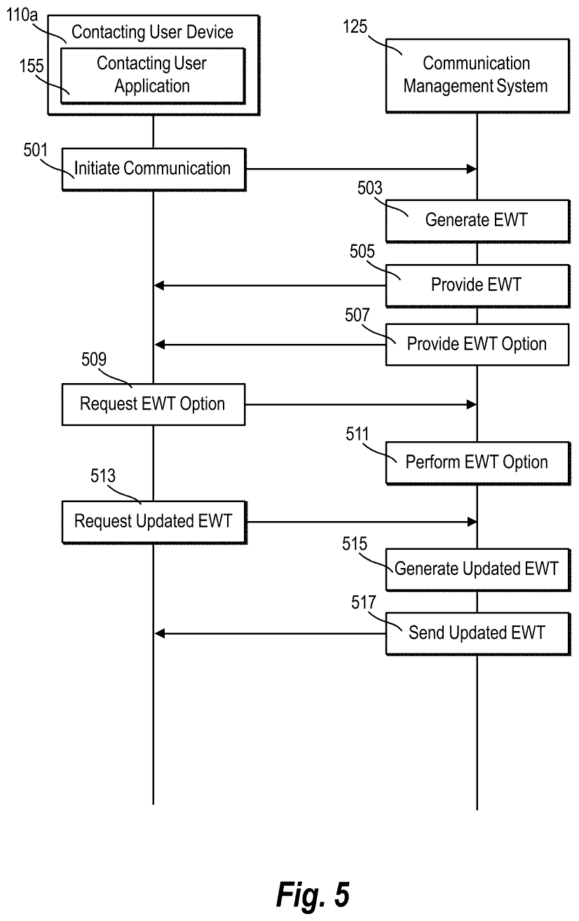

FIG. 5 illustrates a sequence flow diagram of receiving a communication and processing EWT definitions as described above. For example, FIG. 5 shows that a contacting user device can initiate a communication with the communication management system (501). Next, the communication management system 125 can generate an EWT (503) and then provide the EWT (505) to the contacting user device 110a as illustrated in FIG. 5. In addition, the communication management system 125 can provide an EWT option (507) to the contacting user device. For example, and as described above, the communication management system 125 can provide an option to receive the EWT through a different communication channel, request a contact-back communication through the same or different communication channel, or add additional time to the contacting user's wait time. Based on the received request (509), the communication management system performs the EWT option (511). In some embodiments, the communication management system simply performs EWT options without receiving a request from the contacting user device, e.g., in the event the administer sets up an option as a default option.

As further shown in FIG. 5, the contacting user can use the contacting user device to request an updated EWT (513). Upon receiving the request for the updated EWT, the communications management system 125 generates an updated EWT (515) and sends the updated EWT (517). Note, the updated EWT is not based on the contacting user's actual previous wait time, but it is instead based on the system status at the moment of the request (e.g., number of working agents, number of contacting users in the que, average communication times, etc.). Thus, each time the contacting user requests an updated EWT, the communication management system generates a new and best estimated time based on the most current system conditions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates, in block diagram form, an example computing device 600 (e.g., the computing device 600, the contacting user device 110, the agent device 106, and/or the server(s) 104) that may be configured to perform one or more of the processes described above. One will appreciate that the communication management system can comprise implementations of the computing device 600. As shown by FIG. 6, the computing device can comprise a processor 602, memory 604, a storage device 606, an I/O interface 608, and a communication interface 610. Furthermore, the computing device 600 can include an input device such as a touchscreen, mouse, keyboard, etc. In certain embodiments, the computing device 600 can include fewer or more components than those shown in FIG. 6. Components of computing device 600 shown in FIG. 6 will now be described in additional detail.

In particular embodiments, processor(s) 602 includes hardware for executing instructions, such as those making up a computer program. As an example, and not by way of limitation, to execute instructions, processor(s) 602 may retrieve (or fetch) the instructions from an internal register, an internal cache, memory 604, or a storage device 606 and decode and execute them.

The computing device 600 includes memory 604, which is coupled to the processor(s) 602. The memory 604 may be used for storing data, metadata, and programs for execution by the processor(s). The memory 604 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 604 may be internal or distributed memory.

The computing device 600 includes a storage device 606 includes storage for storing data or instructions. As an example, and not by way of limitation, storage device 606 can comprise a non-transitory storage medium described above. The storage device 606 may include a hard disk drive (HDD), flash memory, a Universal Serial Bus (USB) drive or a combination of these or other storage devices.

The computing device 600 also includes one or more input or output (“I/O”) devices/interfaces 608, which are provided to allow a user to provide input to (such as user strokes), receive output from, and otherwise transfer data to and from the computing device 600. These I/O devices/interfaces 608 may include a mouse, keypad or a keyboard, a touch screen, camera, optical scanner, network interface, modem, other known I/O devices or a combination of such I/O devices/interfaces 608. The touch screen may be activated with a writing device or a finger.

The I/O devices/interfaces 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 608 is configured to provide graphical data to a display for presentation to a user. The graphical data may be representative of one or more graphical user interfaces and/or any other graphical content as may serve a particular implementation.

The computing device 600 can further include a communication interface 610. The communication interface 610 can include hardware, software, or both. The communication interface 610 can provide one or more interfaces for communication (such as, for example, packet-based communication) between the computing device and one or more other computing devices 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI. The computing device 600 can further include a bus 612. The bus 612 can comprise hardware, software, or both that couples components of computing device 600 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

FIG. 7 illustrates an example network environment 700 of a communication management system. Network environment 700 includes a contacting user device 702 (e.g., the contacting user device 110), a communication management system , a third-party system 706, and an agent device 708 connected to each other by a network 704. Although FIG. 7 illustrates a particular arrangement of the contacting user device 702, the communication management system , the agent device 708, the third-party system 706, and network 704, this disclosure contemplates any suitable arrangement of the contacting user device 702, the communication management system , the third-party system 706, the agent device 708, and the network 704. As an example, and not by way of limitation, two or more of the contacting user device 702, the communication management system , the agent device 708, and the third-party system 706 may be connected to each other directly, bypassing network 704. As another example, two or more of the contacting user device 702, the communication management system , the agent device 708, and the third-party system 706 may be physically or logically co-located with each other in whole or in part. Moreover, although FIG. 7 illustrates a particular number of contacting user devices 702, communication management systems , agent devices 708, third-party systems 706, and networks 704, this disclosure contemplates any suitable number of contacting user devices 702, communication management systems , agent devices 708, third-party systems 706, and networks 704. As an example, and not by way of limitation, network environment 700 may include multiple contacting user devices 702, communication management systems , agent devices 708, third-party systems 706, and networks 704.

This disclosure contemplates any suitable network 704. As an example, and not by way of limitation, one or more portions of the network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 704 may include one or more networks 704.

Links may connect the contacting user device 702, the communication management system, the agent device 708, and the third-party system 706 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, the contacting user device 702 and/or agent device 708 may be an electronic device including hardware, software, or embedded logic components or a combination of two or more such components capable of carrying out the appropriate functionalities implemented or supported by the contacting user device 702 and/or agent device 708. As an example, and not by way of limitation, a contacting user device 702 or agent device 708 may include any of the computing devices discussed above in relation to FIG. 6. A contacting user device 702 may enable a network user (e.g., a contacting user) at the contacting user device 702 to access the network 704. A contacting user device 702 may enable its user to communicate with other users at other contacting user devices 702 and/or agent devices 708 Likewise, an agent device 708 may enable its user to communicate with contacting user devices 702, third-party systems 706, and/or the communication management system.

In particular embodiments, the agent device 708 is part of (e.g., housed within, either entirely or in part) the third-party system 706. For example, the third-party system 706 may include a service system which maintains one or more agent users, each associated with a separate agent device 708. Accordingly, the communication management system provides various functionality, user interfaces, electronic communications, and other information to the agent device 708 via the third-party system 706. In other embodiments, the agent device 708 is not associated with or part of a third-party system 706. Rather, the agent device 708 refers to a client device associated directly with the communication management system or a different third-party and that communicates with the communication management system without interaction via the third-party system 706.

In particular embodiments, the contacting user device 702 and/or the agent device 708 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at contacting user device 702 and/or agent device 708 may enter a Uniform Resource Locator (URL) or other address directing the web browser to a particular server (such as server, or a server associated with a third-party system 706), and the web browser may generate a Hyper Text Transfer Protocol (HTTP) request and communicate the HTTP request to server. The server may accept the HTTP request and communicate to the contacting user device 702 (or the agent device 708) one or more Hyper Text Markup Language (HTML) files responsive to the HTTP request. The contacting user device 702 and/or agent device 708 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the communication management system may be a network-addressable computing system that can host an online communication network. The communication management system may generate, store, receive, and send messaging data, such as, for example, text data, audio data, and video data. The communication management system can further generate, store, receive, and send other data such as user-profile data, location data, or other suitable data related to the online communication network. The communication management system may be accessed by the other components of network environment 700 either directly or via network 704. In particular embodiments, the communication management system may include one or more servers. Each server may be a unitary server or a distributed server spanning multiple computers or multiple datacenters. Servers may be of various types, such as, for example and without limitation, a web server, a communication server, a news server, a mail server, a message server, an advertising server, a file server, an application server, an exchange server, a database server, a proxy server, or another server suitable for performing functions or processes described herein, or any combination thereof. In particular embodiments, each server may include hardware, software, or embedded logic components or a combination of two or more such components for carrying out the appropriate functionalities implemented or supported by server.

In particular embodiments, the communication management system may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a contacting user device 702, a communication management system, an agent device 708, or a third-party system 706 to manage, retrieve, modify, add, or delete, the information stored in data store.

In particular embodiments, the communication management system may store one or more correspondences in one or more data stores. In particular embodiments, a correspondence may include electronic messages—which may include digital audio, digital video, and/or digital text (e.g., as received in an electronic message or as transcribed from digital audio). The communication management system may provide users (e.g., contacting users) of the online communication network the ability to communicate and interact with other users (e.g., agent users). In particular embodiments, agent users may join the online communication network via the communication management system , and the communication management system may maintain connects for the agent users, including current and historical information relating to contacting users with whom the agent users interact.

In particular embodiments, the communication management system may provide agent users with the ability to take actions on various types of items or objects, supported by communication management system. As an example, and not by way of limitation, the items and objects may include groups or individual contacting users communicating with the communication management system , computer-based applications that a user may use, transactions that allow agent users to buy, return, or sell items or services, indications that allow agent users to report events, or other interactions with various operations that an agent user may perform to assist a contacting user.

In particular embodiments, communication management system may be capable of linking a variety of entities. As an example, and not by way of limitation, communication management system may enable users such as contacting users and agent users to interact with each other as well as receive content from third-party systems 706 or other entities, or to allow users to interact with these entities through an application programming interfaces (API) or other communication channels.

In particular embodiments, a third-party system 706 may include one or more types of servers, one or more data stores, one or more interfaces, including but not limited to APIs, one or more web services, one or more content sources, one or more networks, or any other suitable components, e.g., that servers may communicate with. A third-party system 706 may be operated by a different entity from an entity operating communication management system. In particular embodiments, however, communication management system and third-party systems 706 may operate in conjunction with each other to provide communication services to users of communication management system or third-party systems 706. In this sense, communication management system may provide a platform, or backbone, which other systems, such as third-party systems 706, may use to provide communication services and functionality to users across the Internet or other network.

In particular embodiments, a third-party system 706 may include a third-party service system. A third-party content service system may include one or more sources of products or services that are used by contacting user. As an example, and not by way of limitation, a service system can include a traffic monitoring system, a social networking system, an emergency reporting system, a home repair system, a weather monitoring system, an internet service provider system, an airline system, a transportation provider system, a news media system, a travel accommodation system, an electronic smart appliance distribution or monitoring system, or a power distribution or monitoring system.

In particular embodiments, the communication management system may include a variety of servers, sub-systems, programs, modules, logs, and data stores. In particular embodiments, the communication management system may include one or more of the following: a web server, action logger, API-request server, notification controller, action log, inference module, search module, advertisement-targeting module, user-interface module, user-profile store, third-party content store, or location store. The communication management system may also include suitable components such as network interfaces, security mechanisms, load balancers, failover servers, management-and-network-operations consoles, other suitable components, or any suitable combination thereof. In particular embodiments, the communication management system may include one or more user-profile stores for storing user profiles (e.g., for contacting users). A user profile may include, for example, contacting user information, biographic information, demographic information, behavioral information, social information, or other types of descriptive information, such as work experience, educational history, hobbies or preferences, interests, affinities, or location.

The web server may include a mail server or other messaging functionality for receiving and routing messages between communication management system and one or more contacting user devices 702 or agent devices 706. An API-request server may allow a third-party system 706 to access information from the communication management system by calling one or more APIs. An action logger may be used to receive communications from a web server about a user's actions on or off communication management system. Information may be pushed to a contacting user device 702 and/or agent device 708 as notifications, or information may be pulled from contacting user device 702 responsive to a request received from contacting user device 702 or agent device 708.

What is claimed is:

1. A method comprising:
receiving a definition of an estimated wait time variable from an administrator by a communications management system;
receiving a selection of a ring group for the estimated wait time variable by the communications management system;
receiving a placement of the estimated wait time variable in a contact flow associated with the selected ring group by the communications management system; and
storing the estimated wait time variable including the selected ring group and contact flow placement by the communications management system.

2. The method of claim 1, wherein the definition of the estimated wait time variable comprises one or more of announcement options, contact-back options, and EWT request options.

3. The method of claim 1, further comprising:
receiving a communication from a contacting user;
determining an estimated wait time associated with the communication; and
providing the estimated wait time to the contacting user, wherein the estimated wait time is provided at a point during the contact flow according to the stored estimated wait time variable.

4. The method of claim 3, wherein the point during the contact flow is one or more of at the start of the communication, after an IVR selection, during a waiting or hold period, and after a transfer.

5. The method of claim 3, wherein the estimated wait time is provided to the contacting user via a channel based on the stored estimated wait time variable.

6. The method of claim 1, further comprising:
receiving a communication from a contacting user;
determining one or more options based on the stored estimated wait time variable; and
providing the determined one or more options to the contacting user, wherein the determined one or more options are provided during a point during the contact flow according to the stored estimated wait time variable.

7. The method of claim 6, wherein the one or more options includes one or more of adding time to an estimated wait time and requesting a contact-back.

8. A system comprising:
at least one processor; and
at least one non-transitory computer-readable storage medium storing instructions that, when executed by the at least one processor, cause the system to:
receive a definition of an estimated wait time variable from an administrator;
receive a selection of a ring group for the estimated wait time variable;
receive a placement of the estimated wait time variable in a contact flow associated with the selected ring group; and
store the estimated wait time variable including the selected ring group and contact flow placement.

9. The system of claim 8, wherein the definition of the estimated wait time variable comprises one or more of announcement options, contact-back options, and EWT request options.

10. The system of claim 8, further comprising instructions that, when executed by the at least one processor, cause the system to:
receive communication from a contacting user;
determine an estimated wait time associated with the communication; and
provide the estimated wait time to the contacting user, wherein the estimated wait time is provided at a point during the contact flow according to the stored estimated wait time variable.

11. The system of claim 10, wherein the point during the contact flow is one or more of at the start of the communication, after an IVR selection, during a waiting or hold period, and after a transfer.

12. The system of claim 10, wherein the estimated wait time is provided to the contacting user via a channel based on the stored estimated wait time variable.

13. The system of claim 8, further comprising instructions that, when executed by the at least one processor, cause the system to:
receive a communication from a contacting user;
determine one or more options based on the stored estimated wait time variable; and
provide the determined one or more options to the contacting user, wherein the determined one or more options are provided during a point during the contact flow according to the stored estimated wait time variable.

14. The system of claim 13, wherein the one or more options includes one or more of adding time to an estimated wait time and requesting a contact-back.

15. A non-transitory computer-readable medium storing instructions that, when executed by at least one processor, cause a computer system to:
receive a definition of an estimated wait time variable from an administrator;
receive a selection of a ring group for the estimated wait time variable;
receive a placement of the estimated wait time variable in a contact flow associated with the selected ring group; and
store the estimated wait time variable including the selected ring group and contact flow placement.

16. The computer-readable medium of claim 15, wherein the definition of the estimated wait time variable comprises one or more of announcement options, contact-back options, and EWT request options.

17. The computer-readable medium of claim 15, further comprising instructions that, when executed by the at least one processor, cause the system to:
receive communication from a contacting user;
determine an estimated wait time associated with the communication; and
provide the estimated wait time to the contacting user, wherein the estimated wait time is provided at a point during the contact flow according to the stored estimated wait time variable.

18. The computer-readable medium of claim 17, wherein the point during the contact flow is one or more of at the start of the communication, after an IVR selection, during a waiting or hold period, and after a transfer.

19. The computer-readable medium of claim 17, wherein the estimated wait time is provided to the contacting user via a channel based on the stored estimated wait time variable.

20. The computer-readable medium of claim 15, further comprising instructions that, when executed by the at least one processor, cause the system to:
receive a communication from a contacting user;
determine one or more options based on the stored estimated wait time variable; and
provide the determined one or more options to the contacting user, wherein the determined one or more options are provided during a point during the contact flow according to the stored estimated wait time variable.
